(19) United States
(12) Patent Application Publication
(10) Pub. No.: US 2010/0176956 A1
(43) Pub. Date: Jul. 15, 2010

(54) Device for detecting a body fall into a pool

(76) Inventor: Richard Moerschell, Concord, CA (US)

Correspondence Address: Richard Moerschell, 3880 Landana Ct., Concord, CA, 94519, US

(21) Appl. No.: 12/319,714

(22) Filed: Jan. 10, 2009

(51) Int. Cl. G08B 21/00; G08B 23/00

(52) U.S. Cl. 340/573.6; 340/603; 340/626

(57) ABSTRACT

This invention relates to a water condition indication system for a swimming pool comprising a water condition sensor (110), a memory (130) and a processor (140) and alarm (150). The memory collects and stores the information. The data processor filters the water condition information, corrects for perturbations, and generates an alarm when a body fall into a pool causes a change in the water condition that exceeds a predetermined body entrance criterion. Analysis of the output of one or more filters reduces the occurrence of false alarms while still providing a substantially rapid response time under the prevailing conditions.

### FIELD OF THE INVENTION

The disclosure herein relates generally to a water safety device, and more particularly a pool entry detection system.

### BACKGROUND

Swimming pool drowning accidents lead to hundreds of fatalities and injuries yearly. A number of devices have been developed to address this. Each has deficiencies that, as described below, have prevented their widespread acceptance and use.

A number of devices have been conceived for determining if a body fall into a swimming pool; some are particularly to children. For example, U.S. Pat. Nos. 5,144,285 (Gore), 5,049,859 (Arnell) and 3,810,146 (Lieb), 6,317,050 (Burks), and US Patent application 20040095248 (Mandel) show a type of swimming pool alarm apparatus in which a device must be worn on a child in order to set off the alarm if the child enters the water. Although such devices are very effective and are not subject to false alarms, they have the significant disadvantage that they will not detect a child that has fallen into a pool that is not wearing the transmitter.

Other alarm devices for pools have also been conceived including, for example, the swimming pool alarm of U.S. Pat. No. 4,121,200 (Colmenero) which depends upon water disturbance created by a person in the swimming pool for detection and the device of U.S. Pat. No. 5,023,593 (Brox) which uses passive infrared and acoustic sensors for detecting if a person has fallen into a pool. An infrared detector detects heat and the acoustic element detects waves generated as the body struggles at or below the water surface. Also see U.S. Pat. No. 5,091,714 (de Solminihac) which uses a hydrophone to detect acoustic noises when a person falls in a pool.

Typical of devices which do not require that a transmitter be worn by a person and which rely on ultrasonic or electromagnetic signals are U.S. Pat. No. 5,369,623 to Zerangue and U.S. Pat. No. 5,638,048 to Curry and US patent application publication 2001/0048365 to McFarand. The McFarand device transmits a signal through the pool to a receiving transducer. Entry of a person is detected by disruption of the signal. The Curry patent utilizes sonar, lidar or radar to detect if body has fallen in a pool and discloses a means for preventing false alarms due to self-interference and also due to wind activated waves. Although apparently a useful device, the Curry device appear to suffer from a short-coming in that it may not be able to detect the presence of a foreign body in the corners of the pool nearest the transmitting and receiving transducers because the corners of the pool may not be within the signal cones produced by the transmitting transducer. Curry shows an example in FIG. 9 of his patent using two transmitting and two receiving transducers, but it is believed that this arrangement also suffers from the same problem due to the spacing of the transducers. The Zerangue reference utilizes a plurality of transducers mounted on a support which send and receive acoustic energy into the water of the swimming pool and a control means for activating a transducer to generate a series of pulses from the transducers and a means responsive to changes in the reflected echo pattern received at one of the transducers before the expiration of a pre-determined time period and thus indicative of a foreign body in the transmission path for generating an alarm. Essentially, Zerangue relies on receiving an echo pulse from the foreign body in the pool before the expiration of a predetermined time period. Zerangue relies on a complex device requiring a plurality of spaced transducers. See FIG. 3 of Zerangue. In each case, it is believed that there may be blind spots in coverage, particularly in pools having concave shapes.

Similarly, optical systems using either cameras (Meniere U.S. Pat. No. 6,133,838), IR (Sison, U.S. Pat. No. 6,642,847) or lasers (Fogelson and Valancia, US Patent application publication 20080084318) could suffer from blind spots or the presence of foreign material in the water.

Another class senses either wave motion (Durand, U.S. Pat. No. 7,427,923; Philippe and Montaron, U.S. Pat. No. 7,170,416) or use a hydrophone to detect pressure waves (Hoenig, U.S. Pat. No. 7,019,649). Both techniques require that the entry of person in the water is distinguishable from the wind or other objects.

Haselton (U.S. Pat. No. 3,760,396) proposed use of a pressure switch to measure an increase in pool water level as an indication of entry of body into a pool. The pressure switch communicates to the pool through a throttled inlet line. The effect of wave action is dampened through use of this throttle. The throttle setting is a compromise between providing a rapid response and allowing excessive false alarms, or slower response and fewer false alarms. The Haselton invention does provide for automatic adjustment for the switch to compensate for gradual changes in pool water level due to rain and evaporation. Due to the nature of the electromechanical design, the alarm must be disabled during these automatic adjustments, leaving the pool unprotected during these adjustment intervals. A continuously operational device would be an improvement over the Haselton device. The use of a pressure switch by Haselton instead of a continuous pressure or water level measurement precludes determination of the size of the entrant object.

Hatherell and Walker (US Patent application 20050035866; WIPO PCT/GB2002/002619) used a combination of two signals such as both under water pressure and surface motion to detect an entrant object. Surface motion alone can lead to spurious alarms. This is mitigated by the conjunction of two signals. Surface motion is dependent on the both proximity and shape of the pool. For example, in a concave polygon shaped pool, the pool walls between the detector and entrance point would dampen the surface motion.

In view of the foregoing there is a need for a swimming pool alarm would provide a rapid response in the event of a body fall into the pool yet not suffer from excessive false alarms, be independent of pool geometry, not require the presence of physical barriers, not require that the entrant person wear a particular device, not have blind spots, and not depend on or be affected by noise or wave action generated by the entrant person. The last item is particularly important for young children or others having a physiological condition such that they may not be able generate enough wave action to trigger an alarm.

The present invention relies on a combination of devices and methods that, in conjunction, provide a robust solution which is free from the limitations of the conventional means described above. As described below, the present invention is not reliant on physical barriers, not dependent the rapidity of entry, not dependent on actions taken by the entrant body and is continuously operational. Since water level is substantially uniform within a pool, the present invention will work in any shape pool and have no blind spots. The entrant person does not need to wear any special device nor does the person need to move in the water or even cause a surface motion upon entering the water. Through use of a plurality of filters and a decision matrix, a rapid alarm response is possible without the burden of excessive false alarms. Furthermore, the size of the entrant body can be estimated thereby helping would be rescuers.

### SUMMARY

Disclosed herein is a method and system for detecting the entry of a body into a pool comprising a water condition sensor of the pool water, a memory for acquiring and storing the information from the water condition sensor, a processor for processing the information, and an alarm. The method filters and analyzes the information. The method discards filtered data that are likely to lead to false alarms and instead rely on those filtered data that can reliably be used to determine the entrance of a body into the pool and signal an alarm when a body fall into the pool is detected.

The construction and method of operation of the invention, however, together with additional objectives and advantages thereof will be best understood from the following description of specific embodiments when read in connection with the accompanying drawings.

### BRIEF DESCRIPTION OF DRAWINGS

### Figures

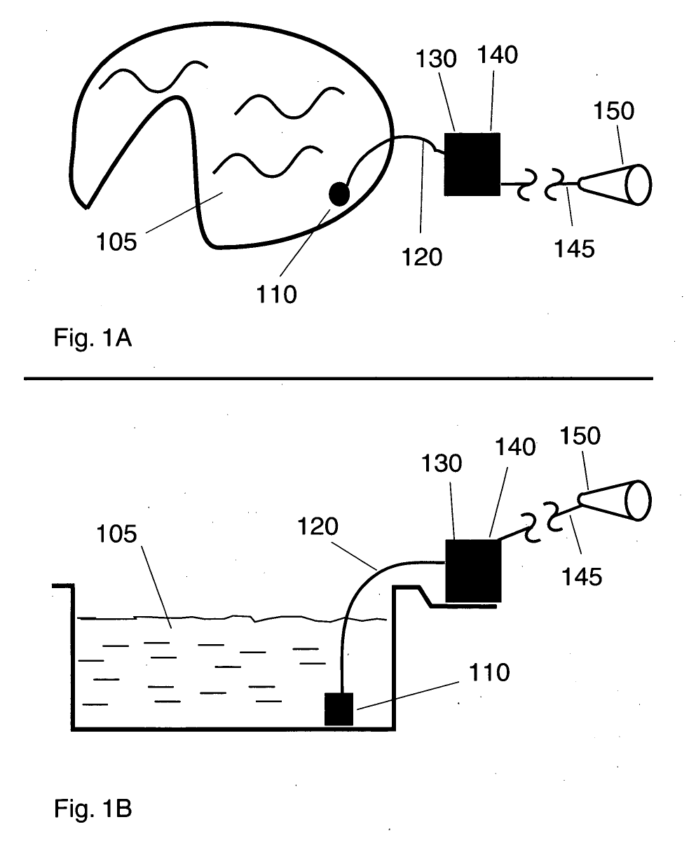

FIGS. 1A to 1B. Illustrates the plan view and elevation view respectively of the system.

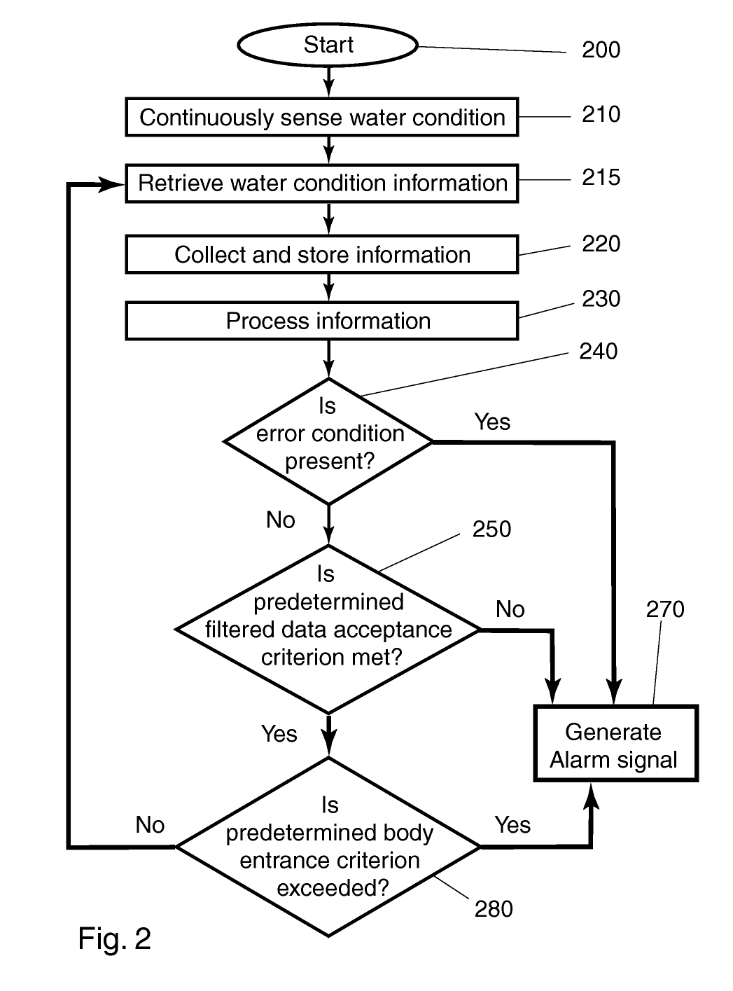

FIG. 2. Illustrates the flow chart for processing the information.

### REFERENCE NUMERALS

105 pool
110 water condition sensor
120 means of communicating water condition information
130 memory
140 processor
145 means of communicating alarm signal
150 alarm
200 Start
210 Continuously sense water condition
215 Retrieve water condition information
220 Collect and store information
230 Process information
240 Is error condition present?
250 Is predetermined filtered data acceptance criterion met?
270 Generate alarm signal
280 Is predetermined body entrance criterion exceeded?

### NOMENCLATURE

Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

Read this application with the following terms and phrases in their most general form. These definitions are provided to facilitate a clear understanding of the present invention. The general meaning of each of these terms or phrases is illustrative, and not in any way limiting.

The term “body” generally refers to a mass capable of displacing water when immersed in a pool such as a person, animal or inanimate object.

The term “pool” (105) generally refers to a vessel containing a fluid that is at least substantially large enough to accommodate a person. The pool could be a swimming pool, Koi pond, fountain or other such vessel. The pool may be of any shape such as round, rectangular, or curvilinear shapes including either concave or convex polygon or curvilinear polygon shapes.

The term “water condition” generally refers to but is not limited to a parameter that is affected by entry of a body into the fluid such as fluid level or fluid pressure. The term “water condition sensor” (110) generally refers to but is not limited to a device used to continually or continuously sense the water condition (210). This measurement of the water condition may be accomplished using an electromechanical device such as a float, or a pressure sensor where the pressure sensor may be a diaphragm, piezo electric device or other type of sensor capable of detecting pressure. Optical, ultrasonic, pressure sensors or other techniques can be used to determine the water level or other water conditions. The water condition sensor may also be configured with a temperature sensitive detector such as a thermocouple, RTD, or other type of sensor capable of detecting temperature. The water condition sensor transmits information including that which is proportional to water level, or water level and temperature. The term “water condition information” generally refers but is not limited to the information comprising parameters descriptive of the fluid in the pool including pressure, level, and temperature and other information that may be provided by the water condition sensor. The signal transmitted by the water condition sensor may be in an analog or digital format, communicated by a means of communicating the water condition information. The term “means of communicating water condition information” (120) generally refers but is not limited to, a cable, fiber optics, antenna or other device capable of communicating an electrical, optical, radio frequency or other signal from the water condition sensor to the memory (130).

The term “top of the pool” refers to the top of the fluid surface, at the fluid interface. The term “bottom of the pool” refers to substantially the deepest point of the pool at substantially the fluid/vessel interface.

The term “data acquisition device” or “memory” (130) generally refers to but is not limited to a device or a memory that retrieves information (215) from the water condition sensor, and collects and stores water condition information (220) from the water condition sensor (110). The memory may also store instructions. The memory is compatible with the type of signal provided by the water condition sensor. For example, an analog signal could be stored in an analog storage device, and for example, a voltage signal could be stored as energy in a capacitor. Alternatively, an analog signal could be digitized and stored in digital form in a memory storage device. Digital electronic signals would be stored in digital form in memory storage device.

The term “data processor” or “processor” (140) generally refers to but is not limited to a device that may serve generally four or five functions; process information (230), optionally determine whether an error condition is present (240), determine whether the predetermined filtered data acceptance criterion are met (250), determine whether the predetermined body entrance criterion are exceeded (280) and generate alarm signal (270). The data processor could be a digital memory storage device or an analog circuit, for electric digital and analog signals respectively. Any or all components of the memory (130) and processor (140) could be located either within the pool or outside the pool.

The term “process information” (230) generally refers to but is not limited to filtering techniques and analysis. The term “filter” generally refers to but is not limited to a method such as sample averaging, a low pass filter, discarding of outlying data, and other techniques used to mitigate noise. Sources of noise that may be filtered include among others, vibration, waves on the pool surface, sampling variation, water condition inhomogeneity, electrical noise, wind and EMI (electromagnetic interference). Environmental factors such as rain and evaporation can be addressed by interpolation and other techniques. The term “analysis techniques” generally refers to and may include tests for errors, data acceptance criterion and body entrance criterion, and processes for data correction such as temperature compensation. The term “water condition inhomogeneities” generally refers but is not limited to temperature and pressure inhomogeneities occurring either spatially or temporally within the pool water. The term “filtered data” generally refers to the water condition information that has been subjected to a filter. The term “noise value” generally refers but is not limited to the result of a noise calculation or its equivalent such as RMS noise calculation, standard deviation and other techniques. The term “predetermined filtered data acceptance criterion” generally refers but is not limited to the maximum permissible noise value such that the entrance of a body as small as the design entrant body can still be substantially detected. The term “error condition” generally refers but is not limited to conditions such as water condition sensor failure, absence of water condition sensor signal, improper power supply parameters, evidence of a short to ground, and communication failure that if severally or jointly met would impair the veracity of the system. The term “valid information” refers to information that has met the predetermined filtered data acceptance criterion. Information, data, and filtered data that have met the predetermined filtered data acceptance criterion, and the results of calculations such as averages that had been derived from data that has met predetermined filtered data acceptance criterion are qualified with the term “valid” such as in valid information or valid average. The term “ΔLₘ” generally refers to the change in water condition information (due to, for example, entrance of a body into the pool) as measured using valid information. The term “ΔL^{j}ₘ” generally refers to a change in water condition information between substantially the current time, t_{now}, and a substantially previous time, tⱼ, that is the equivalent of substantially “j” seconds earlier. For example ΔL^{a}ₘ generally refers to a change in water condition information between the current time, t_{now}, and a previous time, tₐ, that was the equivalent of substantially “a” seconds earlier. Similarly, the term “ΔL^{b}ₘ” generally refers to a change in water condition information between the current time and a previous time that was the equivalent of substantially “b” seconds earlier. L^{now}ₘ, L^{a}ₘ, and L^{b}ₘ, represent water condition information at time t_{now}, tₐ, and t_{b}, respectively.

The term “predetermined body entrance criterion” (280) generally refers but is not limited to the change in water condition information due to the entry into the pool of the design entrant body. The term “design entrant body” generally refers to the smallest body that can be detected by the system upon immersion into the pool. The term “ΔL_{C}” generally refers to the change in water condition information due to entry into the pool of the design entrant body. Due to the effect of pool geometry (i.e. sloping pool walls), ΔL_{C} can be a function of water level and have different values at different pool water levels.

The term “means of communicating alarm signal” (145) generally refers to but is not limited to, a cable, fiber optics, antenna or other device capable of communicating an alarm signal from the data processor to the alarm (150). The term “alarm signal” generally refers to but is not limited to an electrical, optical, mechanical, radio frequency or other medium for the conveyance of information. The means of communicating alarm signal is generally compatible with the type of signal transmitted by the data processor and type of alarm. For example, a simple wire could convey a contact closure as an alarm signal to a locally positioned alarm such as an electric buzzer. Whereas a wireless signal could be communicated to an alarm located either remotely or locally.

The term “alarm” (150) generally refers but is not limited to a buzzer, bell, light, horn, radio, display device such as computer monitor, cell phone or other device or devices that can emit an indicium. The term “indicium” generally refers to but is not limited to sound, light, an optical image, a mechanical action, a chemical action, a video, a video of the pool, a vibration, a cell phone text message, a cell phone call or other signal that can be detected by humans. The alarm signal may be generated (270) and sent to the alarm when the predetermined filtered data acceptance criterion is not met or when the predetermined body entrance criterion is exceeded or when an error condition is present.

### DESCRIPTION OF INVENTION

A change in water condition information detected by the water condition sensor (110) is proportional to the volume displaced by the entrant body which, when immersed, changes a water condition, such an increase in the water level in the pool (105). The memory (130) collects and stores the water condition information. The processor (140) may be employed to, among other tasks, filter the water condition information, detect error conditions, determine whether the predetermined filtered data acceptance criterion is met and determine whether predetermined body entrance criterion is exceeded. An alarm (150) may be triggered when the following conditions jointly or severally occur: an error condition is present (240), the predetermined filtered data acceptance criterion is not met (250), or the predetermined body entrance criterion is exceeded (280).

The method progresses from the start block 200. At block 210, system continuously senses water condition. At block 215, system continuously retrieves the water condition information. At block 220, system collects and stores the information for subsequent analyses. At block 230, system processes the information. The use of three tests improves the reliability of body entrance detection. A decision matrix is used to determine whether a body has entered the pool. At block 240, system may determine whether an error condition is present. If so, an alarm signal may be generated at block 270, if not, the system proceeds to block 250. At block 250, the system may determine whether the predetermined filtered data acceptance criterion is met. If not, an alarm signal may be generated at block 270, if so, the system proceeds to block 280. At block 280, the system determines if the predetermined body entrance criterion is exceeded. If so, an alarm signal may be generated at block 270, if not, the system returns to block 215 to continue with the process. This process is expanded below.

Error conditions as defined above may be detected and may lead to an alarm to provide a warning that the system might not be able to perform properly. Such errors may be due to random events or equipment failure. Alternatively excessive noise conditions may occur, for example, if a submerged object repeatedly disturbed the water condition sensor. In such cases, the filtered data acceptance criterion test would detect the error. Factors such as evaporation, rain and pool filling can lead to an error condition if rate of water level change is great enough to interfere with the body entry signal. A rain gauge or pool fill-pump gauge can be used to determine the rate of water accumulation in the pool allowing the system to correct for this effect. Weather conditions can be used to predict and help correct for the evaporation rate. In cases where a known and predictable perturbation exists, mathematical corrections can be employed. For example, a known rate for pool filling due to, for example, a water pump, can be interpolated. Water condition sensor data taken at different times can then be corrected for the effects of a known rate of change of pool level.

Noise from a number of sources can lead to false alarms. These may be addressed by filtering the water condition information using any combination of filters as defined above. More than one filtering technique may be employed. Filtered data are compared to acceptable limits described by the predetermined filtered data acceptance criterion. Different filtered data are available for subsequent analysis. One or more filters having, for example, different effective time constants, may be employed jointly or severally. For example, a short time constant filtered signal can be used to detect the rapid entrance of a large body into the pool. This has the advantage of providing a rapid alarm response for a body fall into the pool, although one more prone to false alarms. Smaller entrant bodies induce a smaller change in water condition information and are best observed using a long time constant filter having greater signal filtering although requiring more time after body entry to provide reliable detection. Filtered data obtained as a result of a long time constant filter can have a more stringent noise criterion than the data obtained from a short time constant filter. Filtered data having unacceptable noise after processed by a short or fast time constant filter can be ignored in favor of filtered data obtained from filters with longer effective time constants that may have acceptable noise. In such case where the unfiltered water information meets the predetermined filtered data acceptance criterion, a null filter may be used. Filtered data obtained from different filters may have different predetermined filtered data acceptance criterion.

By selecting filtered data from the fastest responding filter that still meets the acceptance criterion, the system provides a fast, robust response yet still mitigates the occurrence of false alarms. In such case that the predetermined filtered data acceptance criterion is not met for data generated by any of the filters, and alarm signal may be communicated to the alarm. Where the filtered data from at least one filter meets the predetermined filtered data acceptance criterion, such data are used body entrance detection.

The value for ΔL_{C}, the predetermined body entrance criterion, may be either calculated from the pool geometry using the size of the design entrant body or determined by correlating the water level increase to insertion of the design entrant body. The ΔL_{C} can be determined with different amounts of water in the pool, for example at half full, ¾ full and full, to take into account the effect of pool geometry.

Body entrance into a pool will displace water in the pool, thereby affecting the water condition as detected by the water condition sensor. The change in water condition may be determined through analysis of data collected over a progression of time. Body entrance determination may be performed by comparing ΔLₘ with the ΔL_{C}. An alarm signal may be generated if ΔLₘ is substantially greater than ΔL_{C} while optionally taking factors such as noise and system drift into account. In such case where more than one ΔL^{j}ₘ are available at current time, being derived from filtered data that met the predetermined filtered data acceptance criterion from more than one filter, each available ΔLₘ can be compared to the predetermined body entrance criterion. If the predetermined body entrance criterion is exceeded for any combination of available ΔLₘ, then an alarm signal may be sent to the alarm. This allows use of the fastest available valid information. Filtered data derived from either fast or slow response filters can trigger the alarm, allowing the fastest response possible within the noise limits of the system.

The alarm signal causes the alarm to emit one or more indicium as a warning that a body has entered the pool. Calibration of water condition relative to the displaced volume of entrant bodies enables the data processor to determine the displacement volume of an entrant body. An indicium may be generated that indicates the presence as well as the size of the entrant body. For example, the displaced volume of the entrant body can be displayed on a digital display or spoken by a text to speech routine.

In a preferred embodiment, the water condition sensor is a stainless steel jacketed, solid-state pressure transducer connected to and housed with a substantially 16 bit analog to digital converter (ADC). This housing may be placed substantially at the bottom of the pool. The range and placement of the pressure transducer is such that when the pool is full, the pressure sensor reading is no higher than substantially 95% of full scale. Placement of the pressure sensor substantially at the pool bottom mitigates the effects of wave action and other near-surface disturbances. The pressure data from the transducer is proportional to the water level in the pool. Use of a 16 bit ADC (or the equivalent) could provide sufficient resolution (65,536 steps) to distinguish entry of a 1 gallon (approximately 8 pounds) body in a typical 25,000 gallon pool. In this case, the design entrant body is a 1 gallon (approximately 8 pound) vessel of water representing an object the size of an infant. Use of an 18 bit ADC would further extend the detection limits. The means of communicating water condition information may be an RS485 cable connecting the pressure sensor to a computer located in a shed near the pool. A power cable provides power to the ADC and pressure transducer. The computer, handling the tasks of both the memory and processor may collect data at substantially 50 Hz from the pressure sensor or at other data collection rates.

Error conditions include unacceptable power consumption of the system, evidence of a short to ground, and an average pressure that is substantially zero, substantially full scale or substantially near a value representative of a failed pressure sensor. If an error condition is present, an alarm signal may be generated.

A boxcar average, or moving average, is used to filter the water pressure data. In the fast response data set, a moving average of n pressure values is calculated and denoted the fast response filtered data. The average and noise of m sequential fast response filtered data are denoted the fast response average and fast response noise respectively. The average and noise of the m sequential most recent fast response filtered data are denoted the fast response current average and fast response current noise respectively. Analogous terminology is applied to the results from a slow response filter where the moving average is determined using p sequential pressure values where p is substantially 10 to 1000 times more than n. The average and noise of the m sequential slow response filtered data are denoted the slow response average and slow response noise respectively. The average and noise of the m sequential most recent slow response filtered data are denoted the slow response current average and slow response current noise respectively. The fast response valid current average is compared to the fast response valid averages that had been collected substantially 1 and substantially 3 seconds previously and are denoted Δ^{f}L¹ₘ and Δ^{f}L³ₘ respectively. If either or both of the previous fast response averages had not met the predetermined filtered data acceptance criterion, then the temporally nearest fast response valid average would be used. The slow response valid current average is compared to the slow response valid averages that had been collected substantially 10 and substantially 30 seconds previously and are denoted Δ^{s}L¹⁰ₘ and Δ^{s}L³⁰ₘ respectively. If either or both of the previous slow response averages had not met the predetermined filtered data acceptance criterion, then the temporally nearest slow response valid average would be used. The predetermined filtered data acceptance criterion is set as the noise value that is substantially half the signal generated by insertion of the design entrant body into the pool. If during the course of analyses of 3 consecutive slow response data sets the predetermined filtered data acceptance criterion is not met for either all three slow response data sets or all fast response data sets over the same interval, then an alarm signal is generated. Differing collection times for the previous fast and slow response data may be employed to effectuate this aspect of the invention.

In the absence of error conditions which would have otherwise triggered an alarm, Δ^{f}L¹ₘ, Δ^{f}L³ₘ, Δ^{s}L¹⁰ₘ, and Δ^{s}L³⁰ₘ are compared to ΔL_{C}, the predetermined body entrance criterion. If any of these ΔLₘ's are greater than the predetermined body entrance criterion then an alarm signal is generated.

In other embodiments, the current averages may be compared to other than two previous averages. Other than two filters may be used as well. Improved filtering can be accomplished by discarding the highest and lowest values prior to calculating the boxcar average, by employing a pre filter, or by employing a different filter entirely.

Calibration of the system may be accomplished in substantially 4 steps to determine the predetermined body entrance criterion. First, the slow response data set average water level is determined after the pool has been in a substantially undisturbed and calm state for substantially 1 minute; this value is stored and denoted ΔLₚᵣₑ. Second, the design entrant body, in this case a plastic jug of water, that weighs substantially 8 pounds and has substantially either positive or neutral buoyancy, is inserted into the water. Third, the slow response data set average is determined in the presence of the design entrant body after the pool has been in a substantially undisturbed and calm state for substantially 1 minute; this value is stored and denoted ΔLₚₒₛₜ. Fourth, the difference between ΔLₚₒₛₜ and ΔLₚᵣₑ is calculated, stored and denoted as the predetermined body entrance criterion (ΔL_{C}). This process may be repeated at different pool water levels generating an array of ΔL_{C} as a function of water level to allow for different pool geometries. Generally, pools do not have a smaller surface area at higher water levels than at lower levels. It is generally sufficient then, for a conservative relationship between displaced volume of the design entrant body and ΔL_{C} to perform the calculation when the pool is filled to its normal operating level. One or more entrant bodies of different displacement volumes can be used to extend the calibrated range of detection and develop a calibration curve. The displacement volume of an unknown entrant body can then be better estimated using this calibration curve.

Initiating system start with the Start function (200) will provide power to the components and begin the method. The alarm may be suppressed until enough data are available for average, noise, error and comparison analysis. Additionally, alarms due to slow response time data sets can be suppressed until such data sets have enough data available for calculations. The system runs continuously thereafter unless the system is stopped.

The alarm signal triggers a warning buzzer in the pool shed and in the pool owner's house. In another embodiment, the processor provides a digital readout or auditory statement of the displaced volume of the entrant body based on the water condition information and the calibration curve.

In the case where the noise in the water condition data is greater than half the signal introduced by the design entrant body, then either a larger design entrant body for calibration may be used or the signal filtering may be increased. Alternatively, a pressure compliant structure may be employed as described below to further dampen the water condition information transmitted by the water condition sensor.

In another embodiment, the both the current average of fast response data set and current average of the slow response data set are compared against the slow response data average determined between substantially 5 and substantially 10 min earlier selected from the lowest pressure value within that 5 minute window that has an acceptable noise value.

In another embodiment, the effects of water condition inhomogeneities are mitigated. Temperature inhomogeneities, warm and cold regions with the pool, can perturb the water condition sensor. By positioning a temperature sensor substantially adjacent to the water condition sensor, the local temperature can be determined and used to correct the water condition information thereby mitigating the effect of temperature inhomogeneities. Pressure inhomogeneities can introduce noise to the water condition information as well. This may be mitigated by covering the water condition sensor, such as a pressure sensor, with a pressure compliant structure such as bladder filled with gas or closed cell foam. The pressure compliant structure transmits the pool water pressure to the pressure sensor. A bladder having a dimension substantially equivalent to the wave length of the typical waves in the pool operates well, however, differing bladder dimensions may be employed to effectuate this aspect of the invention. This pressure compliant structure acts to lessen the effects of pressure waves on the water condition sensor by both dampening and averaging the pressure effects of the wave peaks and troughs. The pressure within a gas filled bladder can be adjusted to optimize its performance at different depths and other conditions.

In another embodiment, the result of the noise analysis is used to set the effective time constant of a filter thereby providing a filter that automatically adjusts to the conditions. An upper permissible limit may be set for this filter to ensure that the filter time constant is short enough to mitigate the incidence of injury caused by submersion of a person.

In another embodiment, ΔLₘ obtained using a filter with a very slow response time (a very slow response filter) is compared to the predetermined body entrance criterion. The result from this may be used to generate an alarm or to reset an extant alarm depending on the existing water conditions, error conditions, filtered data as compared to the predetermined filtered data acceptance criterion, and ΔLₘ as compared to the predetermined body entrance criterion.

In another embodiment, the computer is replaced with a device having an embedded processor and a memory.

While the system described thus far has been largely based on digital electronics, other designs could be employed. Analog circuitry or electromechanical devices could substitute, by one skilled in the art, for the components described above to achieve the same ends.

The invention described herein addresses the deficiencies of previously described devices. In the present invention, an entrant body is detected in a manner that is independent of pool geometry, does not require the presence of physical barriers, does not require that the entrant person wear a particular device, does not depend on noise or wave action generated by the entrant person, and does not have blind spots or other unprotected areas within the pool. Furthermore, since the present invention effectively addresses noise and wave perturbations and, in fact, does not even require wave generation or other action from the entrant body, the present invention works for people that, having slipped into a pool, may not be able to generate enough wave action to activate conventional body entry detectors. By using a high resolution water condition sensor, body entry can be detected at substantially any pool water level. Use of a high resolution water condition sensor in conjunction with the algorithms described in this invention allow continuous detection for the occurrence of body entry without requiring the system to be disabled for periodic recalibration yet providing a robust assay for a body fall into a pool while mitigating the occurrence of false alarms.

References in the specification to “one embodiment”, “an embodiment”, “an example embodiment”, etc., indicate that the embodiment described may include a particular feature, structure or characteristic, but every embodiment may not necessarily include the particular feature, structure or characteristic. Moreover, such phrases are not necessarily referring to the same embodiment. Further, when a particular feature, structure or characteristic is described in connection with an embodiment, it is submitted that it is within the knowledge of one of ordinary skill in the art to effect such feature, structure or characteristic in connection with other embodiments whether or not explicitly described. Parts of the description are presented using terminology commonly employed by those of ordinary skill in the art to convey the substance of their work to others of ordinary skill in the art.

The above illustration provides many different embodiments or embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

What is claimed is:

1) A method for detecting the entry of a body into a pool comprising the following steps in any order:
sensing of water condition in said pool using a water condition sensor;
acquiring and storing the water condition information;
processing of said water condition information
to filter said water condition information using a filter,
to determine a change in filtered data, and
sending an alarm signal to an alarm
when a predetermined body entrance criterion is exceeded.

2) The method of claim 1 wherein said water condition sensor is a pressure sensor that is positioned substantially near the bottom of said pool.

3) The method of claim 1 wherein displaced volume of said body is determined from a relationship of said water condition to displaced volume of body or bodies of known displaced volume, and wherein the alarm indicium comprises qualitative or quantitative information regarding the displaced volume of entrant body.

4) The method of claim 1 further comprising steps for mitigating the effects of water condition inhomogeneities within said pool on the water condition sensor.

5) The method of claim 1 further comprising steps for determining when an error condition is present and for sending the alarm signal to said alarm when error condition is present.

6) The method of claim 1 further comprising steps for determining when a predetermined filtered data criterion is not met and for sending the alarm signal to said alarm when a predetermined filtered data criterion is not met.

7) The method of claim 1 further comprising steps for determining when the error condition is present and when a predetermined filtered data criterion is not met, and for sending the alarm signal to said alarm when a predetermined filtered data criterion is not met or when the error condition is present, wherein said filter is a plurality of filters.

8) A system comprising a water condition sensor, a means of communicating water condition information to a memory, wherein said memory acquires and stores said water condition information from the water condition sensor, a processor wherein said processor filters the information with the filter, analyzes the information, determines a change in the filtered data, and sends said alarm signal to said alarm through a means of communicating alarm signal when said predetermined body entrance criterion is exceeded.

9) The water condition sensor of claim 8 wherein said water condition sensor is a pressure sensor that is positioned substantially near the bottom of said pool.

10) The alarm of claim 8 wherein said alarm emits an indicium comprising qualitative or quantitative information regarding the displaced volume of said entrant body where the displaced volume of the entrant body is determined from the relationship of said water condition to the displaced volume of said body or bodies of known displaced volume.

11) The system of claim 8 further comprising a means for mitigating the effects of water condition inhomogeneities within said pool on the water condition sensor.

12) The processor of claim 8 wherein said processor further determines when the error condition is present and sends said alarm signal to said alarm when the error condition is present.

13) The processor of claim 8 wherein said processor further determines when the predetermined filtered data criterion is not met and sends said alarm signal to said alarm when the predetermined filtered data criterion is not met.

14) The processor of claim 8 wherein said processor further determines when the error condition is present and when a predetermined filtered data criterion is not met, and sends the alarm signal to said alarm when a predetermined filtered data criterion is not met or when the error condition is present, wherein said filter is a plurality of filters.

15) One or more processor readable storage devices having processor readable code embodied on said processor readable storage devices, said processor readable code for programming one or more processors to perform a method comprising of the following steps in any order:
sensing of water condition in said pool using the water condition sensor;
acquiring and storing of said water condition information;
processing of said water condition information
to filter said water condition information using the filter,
to determine a change in the filtered data, and
sending an alarm signal to an alarm
when a predetermined body entrance criterion is exceeded.

16) The method of claim 15 wherein said water condition sensor is a pressure sensor that is positioned substantially near the bottom of said pool.

17) The method of claim 15 wherein displaced volume of said body is determined from a relationship of said water condition to displaced volume of body or bodies of known displaced volume, and wherein the alarm indicium comprises qualitative or quantitative information regarding the displaced volume of entrant body.

18) The method of claim 15 further comprising steps for mitigating the effects of water condition inhomogeneities within said pool on the water condition sensor.

19) The method of claim 15 further comprising steps for determining when the error condition is present and for sending the alarm signal to said alarm when the error condition is present.

20) The method of claim 15 further comprising steps for determining when the predetermined filtered data criterion is not met and for sending the alarm signal to said alarm when the predetermined filtered data criterion is not met.

21) The method of claim 15 further comprising steps for determining when the error condition is present and when a predetermined filtered data criterion is not met, and for sending the alarm signal to said alarm when a predetermined filtered data criterion is not met or when the error condition is present, wherein said filter is a plurality of filters.
